(19) United States
(12) Patent Application Publication
(10) Pub. No.: US 2011/0013384 A1
(43) Pub. Date: Jan. 20, 2011

(54) Maintainable Solar LED Paver/Ground Light, Fixture Thereof, and Installation Method Thereof

(75) Inventor: Minson Lu, Taipei (TW)

Correspondence Address: Juan Carlos A. Marquez;c/o Stites & Harbison PLLC, 1199 North Fairfax Street, Suite 900, Alexandria, VA, 22314-1437, US

(73) Assignee: Maki Solar Technologies Inc., Jhongli City (TW)

(21) Appl. No.: 12/502,355

(22) Filed: Jul. 14, 2009

(51) Int. Cl. F21L 4/08; B23P 11/00

(52) U.S. Cl. 362/183; 29/525.11

(57) ABSTRACT

A maintainable solar LED paver/ground light, a fixture thereof, and an installation method thereof are disclosed. The solar LED paver/ground light includes a fixture, a solar lighting device, and a frame. The fixture has a base plate and a housing such coupled that an exposed portion of the base plate juts out of the housing. The solar lighting device is settled in the housing and the frame is affixed atop the housing so that a light-emitting surface of the solar lighting device is exposed at an opening of the frame. The frame is affixed to the fixture by screws so it is easy to remove for facilitating maintenance of the solar lighting device. A ballast block is arranged on the exposed portion of the base plate so as to fix the solar LED paver/ground light and prevent the solar LED paver/ground light from unintentional displacement due to ambient factors.

### BACKGROUND OF THE INVENTION

1. Technical Field

The present invention relates to a maintainable solar LED paver/ground light, a fixture thereof, and an installation method thereof. More particularly, the present invention relates to a structure, a fixture, and an installation method of a maintainable underground solar lighting device.

2. Description of Related Art

As solar energy has been recognized as a pollution-free, substitute source of energy, and possesses numerous benefits such as being sustainable, environmentally friendly, easy to collect and apply, and economical, it is now a worldwide trend to develop applications of solar energy. Additionally, maturity of industries related to semiconductors and light-emitting diodes also significantly adds strength to solar-power applications. For example, combination of light-emitting diodes and solar power devices leads to the birth of solar streetlamps, solar LED paver/ground lights, etc.

For installing a conventional solar LED paver/ground light, it is necessary to firstly excavate a depression on the ground, which hole shall have its circumference slightly greater than that of the solar LED paver/ground light and applied with adhesive, so that the solar LED paver/ground light can be then placed and fixed in the depression. However, during insertion of the solar LED paver/ground light, the adhesive tends to overflow the depression and become exposed at the outer periphery of the solar LED paver/ground light. Thus, it is an inconvenience to clean the adhesive smearing the surface of the solar LED paver/ground light at the end of installation.

Besides, for the sake of esthetic appearance, the conventional solar LED paver/ground light typically has a transparent, smooth housing. The smoothness of the housing is nevertheless unfavorable to the aforementioned adhesion. As a result, the conventional solar LED paver/ground light may easily come off or loose from the depression where it is installed under frequent external impact. In addition, the groundwater pressure normally giving an upward force may also unintentionally displace the solar LED paver/ground light from where it is installed.

On the other hand, the conventional solar LED paver/ground light is unavoidably damaged and worn by pedestrians or vehicles that frequently tread thereon. Thus, after a long term of use, when the conventional solar LED paver/ground light needs to be replaced, before the installation of a new lamp, the ground therearound has to be destructively broken and the previously installed lamp has to be forcedly dug out. Thus, maintenance of the conventional solar LED paver/ground light is time-consuming, effort-consuming and extremely inconvenience.

### SUMMARY OF THE INVENTION

One objective of the present invention is to provide a maintainable solar LED paver/ground light, a fixture thereof, and an installation method thereof, wherein a frame is detachably affixed to a housing of the fixture by means of screws, so that the frame can be easily removed to allow replacement of a solar lighting device in the fixture without the need of breaking the ground therearound.

Another objective of the present invention is to provide a maintainable solar LED paver/ground light, a fixture thereof, and an installation method thereof, wherein a frame is coupled with a housing of the fixture by secure bolts so the a solar lighting device in the fixture is secured against theft.

Another objective of the present invention is to provide a maintainable solar LED paver/ground light, a fixture thereof, and an installation method thereof, wherein a ballast block is arranged on an exposed portion of a base plate so as to firmly position the solar LED paver/ground light in the ground by preventing the same from unintentional displacement caused by frozen water or excessive water pressure that pushes the solar LED paver/ground light upward.

Another objective of the present invention is to provide a maintainable solar LED paver/ground light, a fixture thereof, and an installation method thereof, wherein an anticorrosive plastic polymer is provided outside the fixture so as to effectively protect the fixture from corrosion, thereby making the solar LED paver/ground light suitable to all environmental demands.

To achieve these and other objectives, the maintainable solar LED paver/ground light of the present invention includes a fixture, a solar lighting device and a frame. The fixture has a base plate and a housing, wherein the housing includes a bottom plate that is such coupled with the base plate that at least one exposed portion of the base plate juts out of the housing, and a peripheral wall that is vertically combined with the bottom plate so as to define an accommodating space. The solar lighting device is settled in the accommodating space. The frame has an opening and is coupled with a top surface of the peripheral wall so that a light-emitting surface of the solar lighting device is exposed at the opening.

To achieve these and other objectives, the fixture of the present invention includes a base plate and a housing. The housing includes a bottom plate that is such coupled with the base plate that at least one exposed portion of the base plate juts out of the housing, and a peripheral wall that is vertically combined with the bottom plate so as to define an accommodating space.

To achieve these and other objectives, the installation method of the present invention includes: placing a fixture on a surface, wherein the fixture includes a base plate; and a housing including a bottom plate that is such coupled with the base plate that at least one exposed portion of the base plate juts out of the housing, and a peripheral wall that is vertically combined with the bottom plate so as to define an accommodating space; setting a ballast block on the exposed portion for fix the fixture; installing a solar lighting device in the accommodating space; and affixing a frame to a top surface of the peripheral wall so that a light-emitting surface of the solar lighting device is exposed at an opening of the frame, while upper surfaces of the frame, the solar lighting device, and the ballast block are coplanar.

By implementing the present invention, at least the following progressive effects can be achieved:

1. The frame detachably affixed to the housing by screws can be easily removed so as not to break the ground for replacing the solar lighting device;

2. The frame may be fastened with the housing by secure bolts and so as to secure the solar lighting device against thievery;

3. A ballast block is arranged on the exposed portion of a base plate to firmly position the solar LED paver/ground light in the ground so as to prevent the solar LED paver/ground light from unintentional displacement caused by frozen water or excessive water pressure that pushes the solar LED paver/ground light upward; and

4. An anticorrosive plastic polymer may be provided outside the fixture to effectively protect the fixture from corrosion, thereby making the solar LED paver/ground light suitable to all environments.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is an exploded view of a maintainable solar LED paver/ground light according to a first embodiment of the present invention;

FIG. 2 is an exploded view of a fixture for the maintainable solar LED paver/ground light according to the first embodiment of the present invention;

FIG. 3A is a sectional view of the fixture according to one concept of the present invention;

FIG. 3B is a sectional view of the fixture according to another concept of the present invention;

FIG. 4 is a block diagram of a solar lighting device of the present invention;

FIG. 5 is a schematic drawing illustrating the assembly of the maintainable solar LED paver/ground light of the present invention;

FIG. 6 is a flow chart illustrating an installation method for the maintainable solar LED paver/ground light according to the present invention; and

FIGS. 7A through 7E are schematic drawings illustrating the installation method for the maintainable solar LED paver/ground light according to the present invention.

### DETAILED DESCRIPTION OF THE PREFERRED EMBODIMENTS

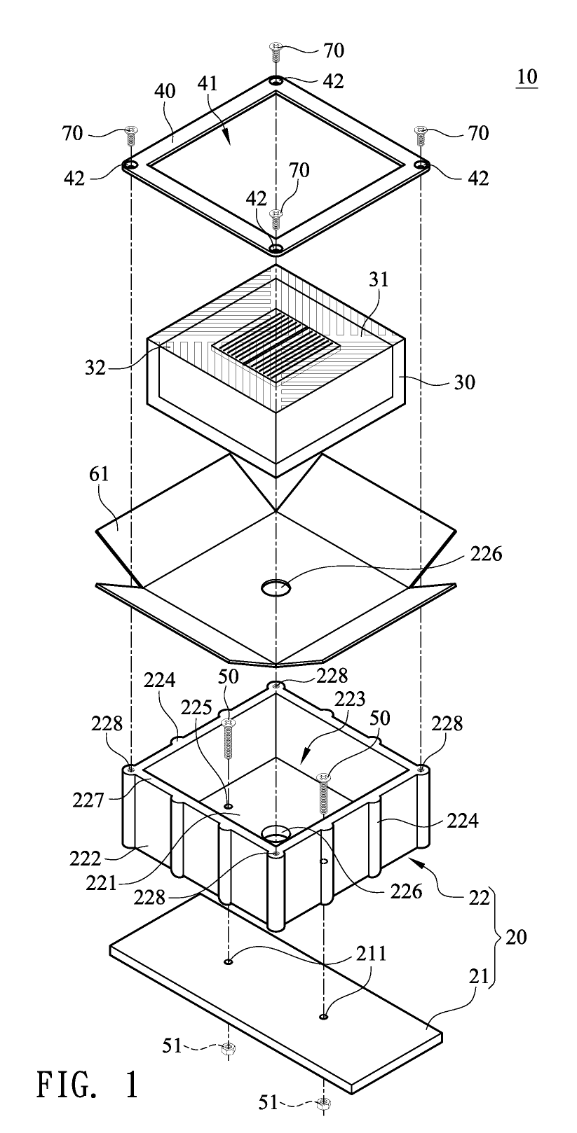

Referring to FIG. 1, a maintainable solar LED paver/ground light 10 according to one embodiment of the present invention includes a fixture 20, a solar lighting device 30, and a frame 40.

The fixture 20 has a base plate 21 and a housing 22 that may be made of an identical material, such as metal. For preventing the base plate 21 and the housing 22 from rusting due to ambient moisture, or, for preventing the base plate 21 and the housing 22 from corroding when the region where the maintainable solar LED paver/ground light 10 is to be installed is of acid geology, an antirust layer or an anticorrosive layer may be provided on surfaces of the base plate 21 and the housing 22. The antirust layer or the anticorrosive layer may be a plastic protective layer made of PVC, PC or the like.

The base plate 21 is structurally a lengthwise base plate, a square base plate, a round base plate, or an irregular-shaped base plate. In addition, at least one second hole 211 is formed on the base plate 21 for allowing the base plate 21 to be coupled with the housing 22.

The housing 22 has a bottom plate 221 and a peripheral wall 222. The peripheral wall 222 and the bottom plate 221 are vertically combined so as to jointly define an accommodating space 223. The bottom plate 221 is structurally a round bottom plate, a square bottom plate, a lengthwise bottom plate, or an irregular-shaped bottom plate. The peripheral wall 222 extends vertically upward from a periphery of the bottom plate 221 so as to define the accommodating space 223 for accommodating the solar lighting device 30. Thus, for meeting various practical needs, and for answering to requirements in respect of installation site and artistry, the fixture 20 may be a round fixture, a square fixture, a lengthwise fixture, or an irregular-shaped fixture.

At least one rib 224 is formed at an outer surface of the housing 22. In the present embodiment, plural said ribs 224 are peripherally formed the outer surface of the housing 22, so as to enhance friction between the housing 22 and an external substance contacting therewith, such as sand, cement, gravel, and so on. By the ribs 224, the fixture 20 can be firmly positioned in the ground without slide.

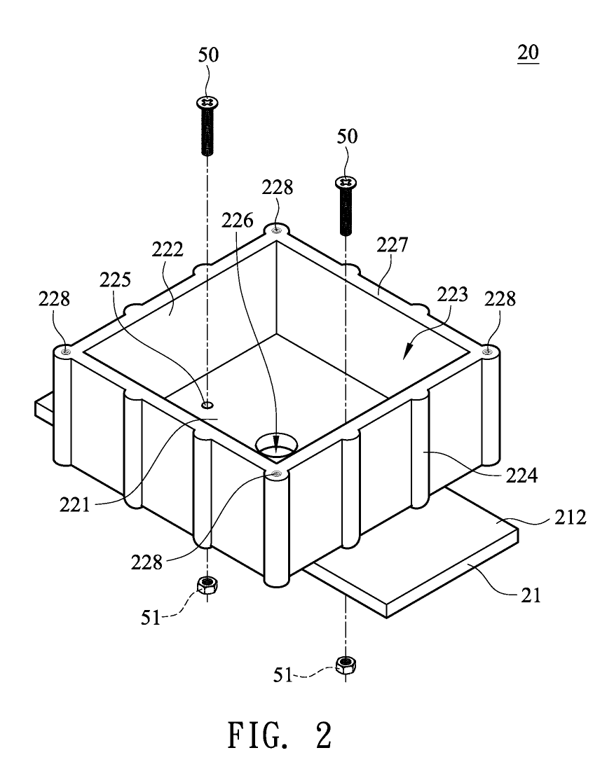

As shown in FIGS. 1 and 2, the bottom plate 221 is formed with at least one third hole 225 corresponding to the second hole 211 so that a screw 50 piercing through the second hole 211 and the third hole 225 can get coupled with a nut 51, thereby combining the bottom plate 221 and the base plate 21. Furthermore, the base plate 21 assembled with the bottom plate 221 has at least one exposed portion 212 jutting out of the housing 22.

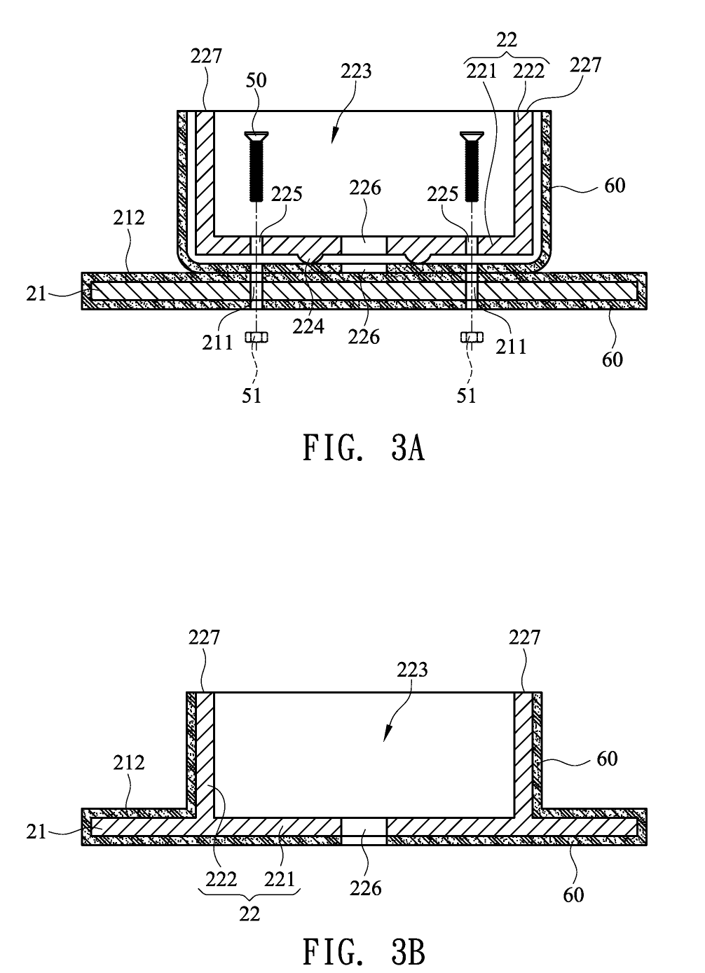

In order to prevent water or other liquid entering the solar LED paver/ground light 10 from accumulating in the housing 22 of the solar LED paver/ground light 10, at least one drain outlet 226 is provided on the bottom plate 221 of the housing 22, as shown in FIG. 3A, for draining purpose, thereby protecting the solar lighting device 30 from damage brought by moisture.

Referring to FIG. 3B, for simplifying manufacture of the fixture 20, the base plate 21 and the housing 22 may be integrally formed. In the present embodiment, the base plate 21 extends bilaterally at two sides of the bottom plate 221 of the housing 22. Similarly, for preventing water or other liquid from accumulating in the solar LED paver/ground light 10, at least one drain outlet 226 is provided on the bottom plate 221 integrally formed with the fixture 20 for draining out water or other liquid.

Meantime, since the solar LED paver/ground light 10 may be installed at a region with acid soil or of acid geology, for preventing the fixture 20 from corroding, an anticorrosive plastic polymer 60 may be provided outside the base plate 21 and the housing 22 of the fixture 20 to wrap outer surfaces of the base plate 21 and the peripheral wall 222 of the housing 22, and the bottom plate 221, as shown in FIG. 3A. Alternatively, as can be seen in FIG. 3B, the anticorrosive plastic polymer 60 may be provided outside the base plate 21 and the peripheral wall 222 of the housing 22 for anticorrosive purpose.

Referring back to FIG. 1, the solar lighting device 30 is deposited in the accommodating space 223 of the housing 22. Moreover, for preventing the solar lighting device 30 and the housing 22 of the solar LED paver/ground light 10 from mutual impact under external impact or vibration, a cushion 61 is settled between the housing 22 and the solar lighting device 30 as a buffer that protects the solar lighting device 30. The cushion 61 is also formed with a drain outlet 226. The drain outlet 226 may be located anywhere on the cushion 61 or may be located corresponding to the drain outlet 226 of the bottom plate 221, so as to provide the solar LED paver/ground light 10 with excellent drainage effect.

Furthermore, as shown in FIG. 3A, in the embodiment where the housing 22 is externally provided with the anticorrosive plastic polymer 60, another drain outlet 226 is formed on the anticorrosive plastic polymer 60 aligned with the above-mentioned drain outlet 226 for drainage. Meantime, since intervals do exist between the anticorrosive plastic polymer 60 outside the housing 22 and the anticorrosive plastic polymer 60 outside the base plate 21, water may also flow out through the intervals. Referring to FIG. 3B, when the base plate 21 and the housing 22 are integrally formed, the anticorrosive plastic polymer 60 outside the base plate 21 also has a drain outlet 226 that intercommunicates with the drain outlet 226 of the fixture 20 for draining water in the fixture 20. Thereby, it is prevented that ice formed by accumulated water pushes the solar LED paver/ground light 10 out of the ground when the weather becomes cold.

The solar lighting device 30 may have a waterproof structure, so as to be suitable for outdoor use. In addition, a light-emitting surface 31 of the solar lighting device 30 is processed to be an anti-slip surface. For example, the light-emitting surface 31 of the solar lighting device 30 is formed with non-slip lines 32, so that safety of pedestrians and vehicles passing the solar LED paver/ground light 10 in rainy days and high-moisture days can be ensured.

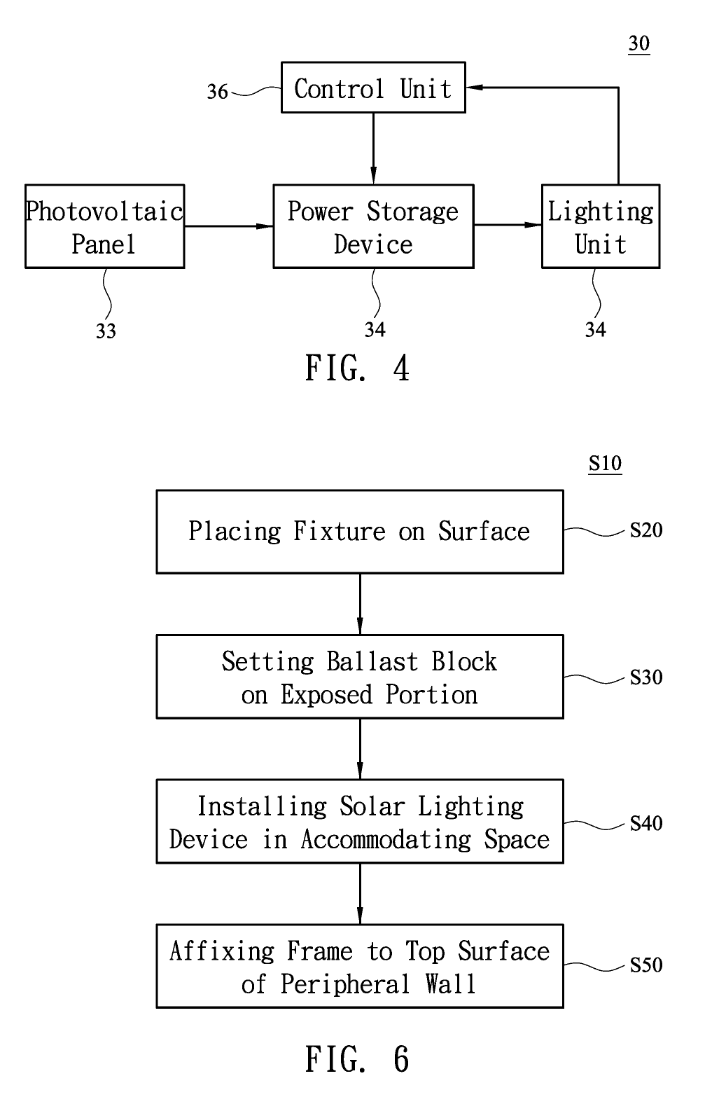

Referring to FIG. 4, the solar lighting device 30 may include a photovoltaic panel 33 a power storage device 34, a lighting unit 35 and a control unit 36. Therein, the photovoltaic panel 33 absorbs solar energy and converts the same into electrical energy to be stored in the power storage device 34. The power storage device 34 may be a battery or a supercapacitor. The control unit 36 may include a plurality of control circuits for controlling the power storage device 34 and the lighting unit 35.

Referring to FIG. 1 again, the frame 40 has an opening 41 and is mounted on a top surface 227 of the peripheral wall 222 of the housing 22. The top surface 227 of the peripheral wall 222 is provided with at least one threaded hole 228 while the frame 40 has a first hole 42 corresponding to the threaded hole 228. Thereby, a screw 70 passing though the first hole 42 is coupled with the threaded hole 228 so as to affix the frame 40 to the top surface 227 of the peripheral wall 222.

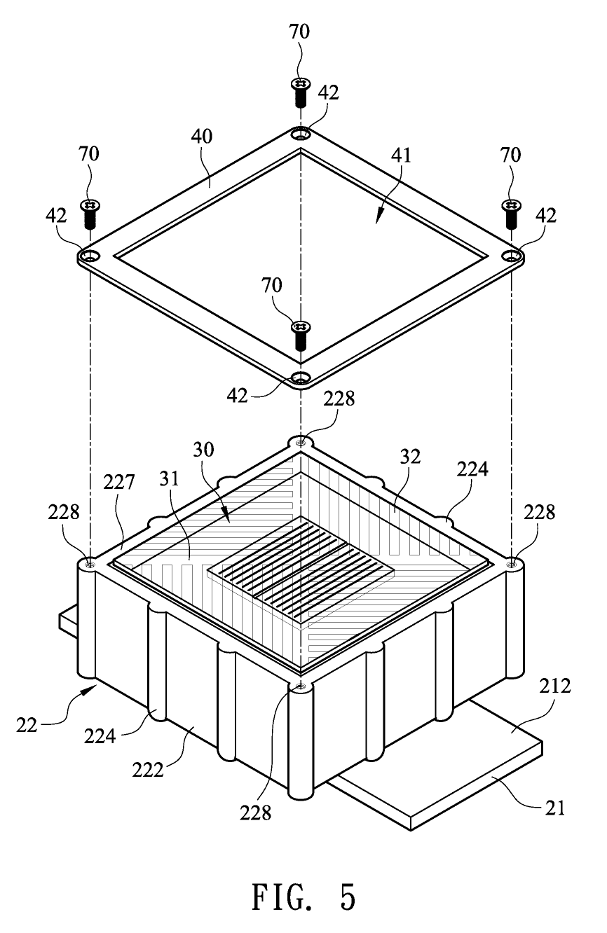

According to FIG. 5, after installed in the housing 22 of the fixture 20, the solar lighting device 30 has an upper part jutting out of the housing 22 of the fixture 20. Hence, the frame 40 affixed to the peripheral wall 222 of the housing 22 makes upper surfaces of the solar lighting device 30 and of the frame 40 level with each other while allowing the light-emitting surface 31 of the solar lighting device 30 to be exposed at the opening 41 of the frame 40, thus facilitating illumination.

Since the frame 40 is affixed to the top surface 227 of the peripheral wall 222 by the screw 70, when it is desired to maintain or replace the solar lighting device 30, the frame 40 can be easily removed to allow maintenance or replacement, so that there is no more needs to break the ground around the solar LED paver/ground light 10 for digging it out. However, for protecting the solar lighting device 30 from thieves, the screw 70 for fastening the frame 40 may be a secure bolt, so that the frame 40 can be only removed by using special tools, thereby facilitating maintenance and ensuring security of the solar lighting device 30 at the same time.

By installing the solar lighting device 30 in the fixture 20, convenient maintenance and replacement of the solar lighting device 30 can be achieved. Meantime, for meeting different environmental conditions of installation sites, and preventing the solar LED paver/ground light 10 from being intentionally displaced by frozen water or excessive groundwater pressure from below, a ballast block 80 may be mounted on the exposed portion 212 of the base plate 21 so that the solar LED paver/ground light 10 can be fixed with enhanced firmness, thus being less likely to displace.

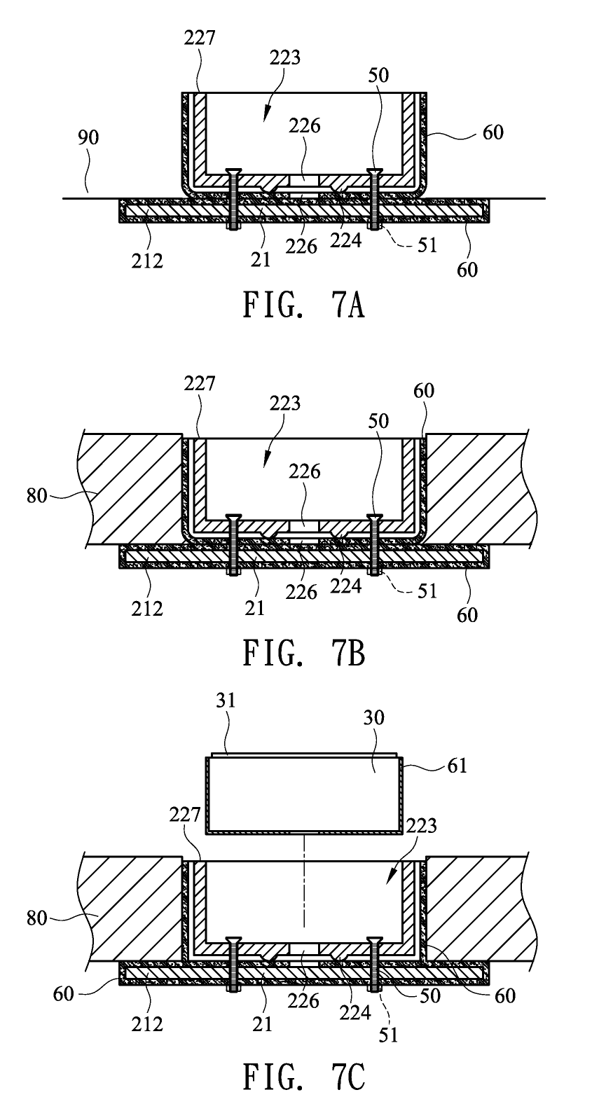

An installation method for installing the solar LED paver/ground light 10 of the present invention is as shown in FIG. 6. The method S10 includes the following steps: placing the fixture on a surface S20, setting the ballast block on the exposed portion S30, installing the solar lighting device in the accommodating space S40, and affixing the frame to the top surface of the peripheral wall S50.

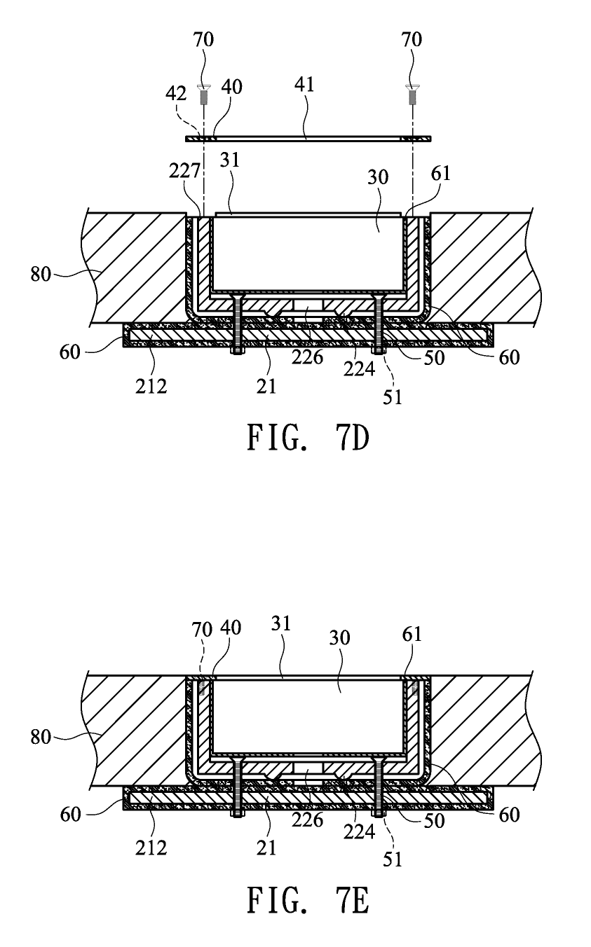

In the step of placing the fixture on a surface S20, as shown in FIG. 7A, the fixture 20 is placed on a surface 90. The surface 90 may be, but not limited to, a soil surface or a cement floor. As the structure of the fixture 20 has been provided previously, it needs not to be described in any length herein. Meantime, the base plate 21 of the fixture 20 may be embedded in the surface 90 with its upper surface level with the surface 90.

In the step of setting the ballast block on the exposed portion S30, referring to FIG. 7B, since the exposed portion 212 of the base plate 21 juts out of the housing 22 of the fixture 20, the ballast block 80 may be arranged on the exposed portion 212 for pressing and positioning the fixture 20. The ballast block 80 may be, but is not limited to, a cement block, a brick, a rock, a stone, a woodblock, etc. The ballast block 80 is of a material suitable to the ambient conditions of the installation site so as to fix and prevent the fixture 20 from unintentional displacement under external impact or push. In the embodiment where the anticorrosive plastic polymer 60 is provided outside the housing 22, the ballast block 80 abuts against the anticorrosive plastic polymer 60.

In the step of installing the solar lighting device in the accommodating space S40, referring to FIG. 7C, the solar lighting device 30 is settled in the accommodating space 223 of the housing 22. Alternatively, the solar lighting device 30 may be firstly wrapped by the cushion 61 and then placed into the accommodating space 223 of the housing 22.

In the step of affixing the frame to the top surface of the peripheral wall S50, referring to FIG. 7D, after the solar lighting device 30 is placed in the accommodating space 223 of the housing 22, an upper part of the solar lighting device 30 remains exposed outside the housing 22 of the fixture 20. Thus, after the frame 40 is mounted onto the top surface 227 of the peripheral wall 222 of the housing 22, the upper surfaces of the frame 40 and the solar lighting device 30 are coplanar while the light-emitting surface 31 of the solar lighting device 30 is exposed at the opening 41 of the frame 40 for illumination.

However, it is even more important that the upper surfaces of the ballast block 80 and the frame 40 and the solar lighting device 30 are level, so that the installed solar LED paver/ground light 10 has an overall flat top surface without any prominence, as shown in FIG. 7E. After the solar LED paver/ground light 10 is installed as mentioned above, there may be intervals existing between the solar LED paver/ground light 10 and the ballast block 80. Thus, sand may be further filled between the ballast block 80 and the housing 22, or between the ballast block 80 and the anticorrosive plastic polymer 60 (not shown).

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A maintainable solar LED paver/ground light comprising:
a fixture having:
a base plate; and
a housing including:
a bottom plate coupled with the base plate so that at least one exposed portion of the base plate juts out of the housing; and
a peripheral wall vertically combined with the bottom plate so as to define an accommodating space;
a solar lighting device settled in the accommodating space; and
a frame having an opening and coupled with a top surface of the peripheral wall so that a light-emitting surface of the solar lighting device is exposed at the opening.

2. The solar LED paver/ground light of claim 1, wherein the base plate is a lengthwise base plate, a square base plate, a round base plate, or an irregular-shaped base plate.

3. The solar LED paver/ground light of claim 1, wherein at least one threaded hole is provided at the top surface, and a first hole is formed on the frame corresponding to the threaded hole so that a screw piercing through the first hole and the threaded hole couples the frame with the top surface.

4. The solar LED paver/ground light of claim 3, wherein the screw is a secure bolt.

5. The solar LED paver/ground light of claim 1, wherein the solar lighting device comprises a power storage device, a lighting unit, a control unit, and a photovoltaic panel.

6. The solar LED paver/ground light of claim 1, further comprising a cushion settled between the housing and the solar lighting device.

7. A fixture for being used with a maintainable solar LED paver/ground light, the fixture comprising:
a base plate; and
a housing including:
a bottom plate coupled with the base plate so that at least one exposed portion of the base plate juts out of the housing; and
a peripheral wall vertically combined with the bottom plate so as to define an accommodating space.

8. The fixture of claim 7, wherein the base plate is a lengthwise base plate, a square base plate, a round base plate, or an irregular-shaped base plate.

9. The fixture of claim 7, further comprising an antirust layer or an anticorrosive layer at a surface of the fixture.

10. The fixture of claim 7, wherein the bottom plate is a lengthwise bottom plate, a square bottom plate, a round bottom plate, or an irregular-shaped bottom plate.

11. The fixture of claim 7, wherein the base plate and the housing are integrally formed.

12. The fixture of claim 11, wherein the fixture integrally formed from the base plate and the housing further comprises at least one drain outlet.

13. The fixture of claim 7, wherein the bottom plate is formed with at least one drain outlet.

14. The fixture of claim 7, wherein at least one threaded hole is provided at the top surface, and a first hole is formed on the frame corresponding to the threaded hole so that a screw piercing through the first hole and the threaded hole couples the frame with the top surface.

15. The fixture of claim 14, wherein the screw is a secure bolt.

16. An installation method for installing a maintainable solar LED paver/ground light, the method comprising steps of:
placing a fixture on a surface, wherein the fixture comprises a base plate;
and a housing including a bottom plate that is such coupled with the base plate that at least one exposed portion of the base plate juts out of the housing, and a peripheral wall that is vertically combined with the bottom plate so as to define an accommodating space;
setting a ballast block on the exposed portion for fix the fixture;
installing a solar lighting device in the accommodating space; and
affixing a frame to a top surface of the peripheral wall so that a light-emitting surface of the solar lighting device is exposed at an opening of the frame, and upper surfaces of the frame, the solar lighting device, and the ballast block are coplanar.

17. The installation method of claim 16, wherein the ballast block is a cement block, a brick, a rock, a stone, or a woodblock.

18. The installation method of claim 16, further comprising a step of filling sand between the ballast block and the housing.

19. The installation method of claim 16, wherein at least one threaded hole is provided at the top surface, and a first hole is formed on the frame corresponding to the threaded hole so that a screw piercing through the first hole and the threaded hole couples the frame with the top surface.

20. The installation method of claim 19, wherein the screw is a secure bolt.
